(19) United States
(12) Patent Application Publication
(10) Pub. No.: US 2014/0298374 A1
(43) Pub. Date: Oct. 2, 2014

(54) VIDEO DEVICE AND METHOD FOR CONTROL AND MONITORING USAGE OF VIDEO DEVICE

(71) Applicant: HON HAI PRECISION INDUSTRY CO., LTD., New Taipei (TW)

(72) Inventors: JIAN-SHIHN TSANG, New Taipei (TW); CHIA-CHING HSU, New Taipei (TW); MING-HUNG CHUNG, New Taipei (TW)

(73) Assignee: HON HAI PRECISION INDUSTRY CO., LTD., New Taipei (TW)

(21) Appl. No.: 14/067,011

(22) Filed: Oct. 30, 2013

(30) Foreign Application Priority Data
Apr. 2, 2013 (TW) 102111982

(51) Int. Cl. H04N 21/442; H04N 21/454

(52) U.S. Cl. CPC H04N 21/44204; H04N 21/454
USPC 725/29

(57) ABSTRACT

A video device includes a setting unit, a recording unit, a detection unit, a timer, and a control unit. The setting unit sets a viewing allowance time of the child. The recording unit records the child's viewing habit. The detection unit detects whether a child is watching media content on the video device. The timer times a viewing time of the child's viewing habit when the child is watching media content on the video device. The control unit controls the recording to record the child's viewing habit and turns off the video device when the viewing time reaches the viewing allowance time. A method for control and monitoring a child's usage of the video device is also provided.

### BACKGROUND

1. Technical Field

The present disclosure relates to video devices and method for control and monitoring usage of video devices by children.

2. Description of Related Art

Many children spend excessive time watching television or playing video games and in some cases this has resulted in lower scholastic achievement and lessened social development. If not supervised by parents, many children will watch television or play video games for extended periods.

Therefore, there is room for improvement in the art to prevent the above listed problems from occurring.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a video device in accordance with an embodiment;

the video device includes a setting unit.

FIG. 2 is a flowchart of a method for recording a TV program in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

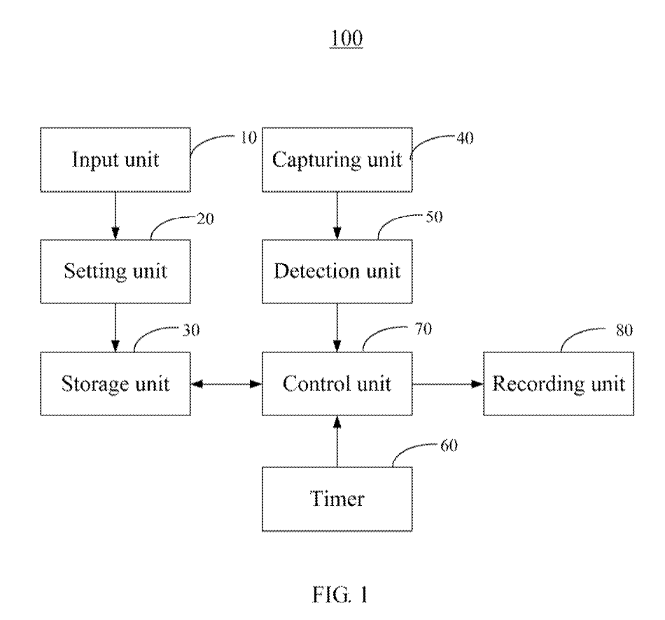

FIG. 1 shows a video device 100 in accordance with an embodiment. The video device 100 permits parents to set a viewing allowance time for a child, and disables viewing of the video device 100 when the child has watched the video device 100 for his allowable viewing time. The video device 100 can be a television, or a computer, for example. In the embodiment, the video device 100 is a television.

The video device 100 includes an input unit 10, a setting unit 20, a capturing unit 40, a detection unit 50, a timer 60, and a control unit 70. The video device 100 further includes a storage unit 30, and a recording unit 80 for recording child's usage history. The usage history records the start time of the child's watching habits, the child's viewing time of media content each time, the name of the media content, for example.

The input unit 10 receives manual operations and generates instructions for controlling the video device 100. The input unit 10 can be buttons/keys, or a touch panel mounted on a housing of the video device 100. The input unit 10 can also be a remote control fitting for the video device 100. The input unit 10 includes a power switch (not shown). The power switch generates a power-off signal and/or a power-on signal when depressed.

The setting unit 20 sets viewing allowance time for the child in response to manual operations. The viewing allowance time include the child's preset viewing time T1 each time, child's total viewing time T2 per day, a preset time interval T3 for allowing child to watch media content again, and the total viewing time over any desired period, such as a week, a month. As a result, parents can adjust the viewing allowance time freely in different periods, for example, the viewing allowance is adjusted to allow child to enjoy a relativity long time during the child's summer vacation.

The storage unit 30 stores the viewing allowance time. The storage unit 30 further stores a characteristic image of the child to be monitored. The characteristic image includes at least facial feature of the child. In another embodiment, the storage unit 30 may store a common feature of children, such as, the feature of the stature being less than 1.4 meter.

The capturing unit 40 captures a video image of watching position in front of the video device 100. The capturing unit 40 in the embodiment is mounted on a front panel of the housing of the video device 100.

The detecting unit 50 detects whether a child is watching the media content on the video device 100 based on the captured video image. In the embodiment, the detecting unit 50 detects a human face in the captured image using a face template matching technology, and then compares the detected human face with the facial feature of the characteristic image. If the detected human face matches with the facial feature of the characteristic image, it is determined that the child is watching media content, and the detecting unit 50 generates a detecting signal. If the detected human face does not match with the facial feature of the characteristic image, it is determined that no child is watching media content, and the detecting unit 50 continues to perform detection.

The timer 60 keeps time. The timer 60 further responds to the detecting signal and times a viewing time T of the child. The timer 60 generates a timing signal when the timed viewing time T reaches the child's preset viewing time T1 each time.

The control unit 70 responds to the timing signal, and controls the recording unit 80 to record the child's viewing habit, and further turns off the video device 100. At the time of the detecting signal is generated, the real time timed by the timer 60 is recorded as the start time of the child watching media content. When the child is absent or away from the watching positioning, the real time timed by the timer 60 is recorded as the end time of the child watching media content.

After the video device 100 is turned off, the control unit 70 further detects whether a power-on signal is received in a predetermined time S, and generates a control signal when a power-on signal is received in the predetermined time S. In the embodiment, the predetermined time S is less than the preset time interval T3 for allowing the child to watch the media content again. The detection unit 50 responds to the control signal and further determines whether the child is watching the media content on the video device 100 based on the captured video image. When the child is watching the media content, the control unit 70 calculates a time interval T4 from the end time of the last viewing habit to the start time of this viewing habit, and further determines whether the calculated time interval T4 is greater than the preset time interval T3. If the calculated time interval T4 is less than the preset time interval T3, it is indicated that the time interval of the child watching media content is too short, and the control unit 70 turns off the video device 100 to prevent the child from watching media content in such short time interval. As a result, the child is prevented from manually turning off the video device 100 when the child's viewing time reaches the allowance time, and further repowering the video device 100 to watch media content again.

If the calculated time interval T4 is greater than the preset time interval T3, the control unit 70 further calculates the total viewing time T5 on the present day based on the viewing history, and further determines whether the total viewing time T5 is greater than the preset total viewing time T2 per day. If the total viewing time T5 is greater than the preset total viewing time T2 per day, the control unit 70 turns off the video device 100 to prevent child's total viewing time from exceeding the preset total viewing time T2. If the total viewing time T5 is less than the preset total viewing time T2 per day, it is indicated that the child is permitted to watch the rest of the preset total viewing time T2, and the timer 60 times the viewing time T again, and the control unit 70 turns off the video device 100 on determination that either the viewing time reaches the preset viewing time T1 each time or the total viewing time on the present day reaches the preset total viewing time T2 per day. The control unit 70 further establishes a report over a week, or a month based on the usage history, to allow parents to learn of child's usage of the video device 100. As a result, parents are allowed to centrally monitor and control their children's use of devices.

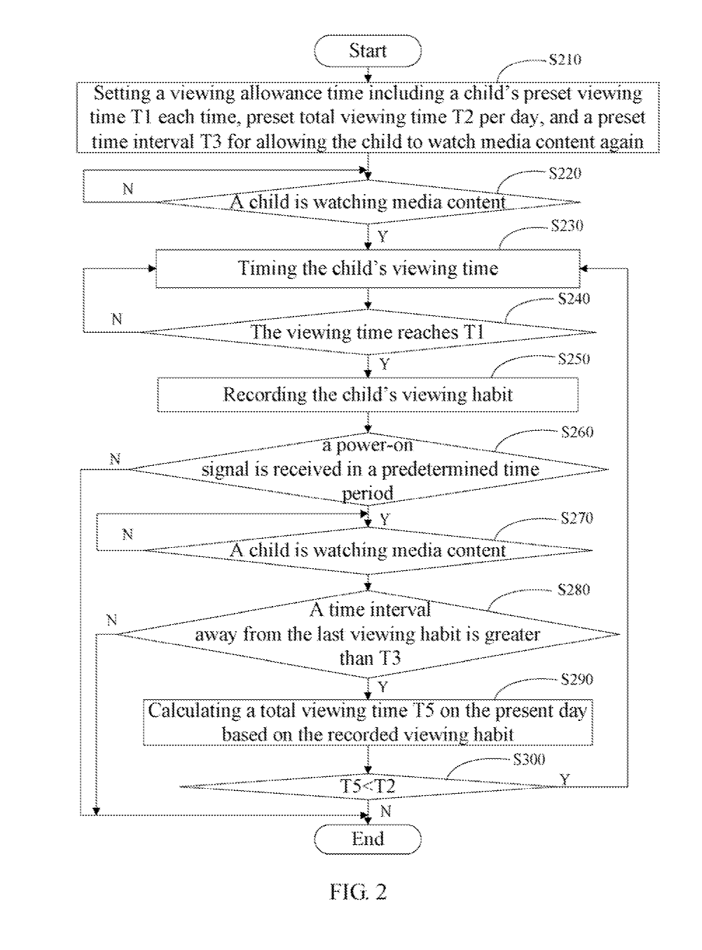

FIG. 2 is a flowchart illustrating one embodiment of a method for controlling and monitoring a child's usage of video device 100. The video device 100 includes an input unit 10 for allowing parents to set a viewing allowance time, a capturing unit 40 for capturing a video image of watching position in front of the video device 100, and a recording unit 80 for recording the child's usage history. The usage history records at least the start time of the child's viewing habit, the child's viewing time of media content each time, the name of the media content. The method includes the following steps:

In step S210, the setting module 20 sets a viewing allowance time for the child in response to manual operations. The viewing allowance time includes the child's preset viewing time T1, the child's total viewing time T2 per day, a preset time interval T3 for allowing child to watch media content again, and the total viewing time over any desired period, such as a week, or a month.

In step S220, the detecting unit 50 detects whether the child is watching the media content on the video device 100. When the child is detected to be watching the media content, the procedure goes to S230. Otherwise, step S220 is repeated.

In step S230, the timer 60 times a viewing time T of the child's viewing habit.

In step S240, the timer 60 further determines whether the viewing time T reaches the child's preset viewing time T1 When the viewing time T reaches the child's preset viewing time T1, the procedure goes to step S250. Otherwise, the procedure returns to step S230.

In step S250, the control unit 70 controls the recording unit 80 to record the child's viewing habit as usage history, and further turns off the video device 100.

In step S260, after the video device 100 is turned off, the control unit 70 further detects whether a power-on signal is received in a predetermined time period. When a power-on signal is received in the predetermined time period, the procedure goes to step S270. Otherwise, the procedure ends.

In step S270, the detecting unit 50 again detects whether the child is watching the media content on the video device 100. When the child is detected to be watching the media content, the procedure goes to S280. Otherwise, the procedure returns to step S270.

In step S280, the control unit 70 calculates a time interval T4 from the end time of the last viewing habit to the start time of this viewing habit, and further determines whether the calculated time interval T4 is greater than the preset time interval T3. When the time interval T4 is greater than the preset time interval T3, the procedure goes to step S290. Otherwise, the procedure ends.

In step S290, the control unit 70 further calculates the total viewing time T5 on the present day based on the recorded viewing history.

In step S300, the control unit 70 determines whether the total viewing time T5 is greater than the preset total viewing time T2 per day. If the total viewing time T5 is greater than the preset total viewing time T2 per day, the video device 100 is turned off (step S310), and the procedure ends. Otherwise, the procedure returns to step S230.

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A video device, comprising;
a setting unit setting a viewing allowance time of a child;
a recording unit recording the child's viewing habit;
a detection unit detecting whether the child is watching media content on the video device;
a timer timing a viewing time of the child's viewing habit when the child is watching media content on the video device; and
a control unit controlling the recording to record the child's viewing habit and turning off the video device when the viewing time reaches the viewing allowance time.

2. The video device of claim 1, wherein the view allowance time comprises the child's preset viewing time each time, a preset total viewing time per day, and a preset time interval for allowing the child to watch media content again.

3. The video device of claim 2, wherein a control unit controls the recording unit to record the child's viewing habit and turns off the video device when the viewing time reaches the child's preset viewing time each time.

4. The video device of claim 3, wherein the control unit further detects whether a power-on signal is received in a predetermined time after the video device is turned off; the detecting unit detects whether the child is watching the media content again when a power-on signal is received in the predetermined time; the control unit detects whether a time interval away from the last viewing habit is greater than the preset time interval, and turns off the video device when the time interval away from the last viewing habit is less than the preset time interval.

5. The video device of claim 4, wherein the control unit further calculates the total viewing time on the present day based on the recorded viewing habit, and determines whether the total view time on the present day is greater than the preset total viewing time per day, and turns off the video device when the total view time on the present day is greater than the preset total viewing time per day.

6. The video device of claim 1, further comprising a capturing unit; wherein the capturing unit captures a video image of watching position in front of the video device, and the detection unit detects whether the child is watching the media content on the video device based on the captured video image.

7. The video device of claim 6, further comprising a storage unit storing a characteristic image of the child to be monitored; wherein the detection determines that the child is watching the media content on the video device when the captured video image matches with the characteristic image.

8. A method for control and monitoring the child's usage of a video device, the method comprising:
setting a viewing allowance time of the child;
detecting whether the child is watching media content on the video device;
timing a viewing time of the child's viewing habit when the child is watching media content on the video device; and
recording the child's viewing habit and turning off the video device when the viewing time reaches the viewing allowance time.

9. The method of claim 8, wherein the view allowance time comprises the child's preset viewing time each time, a preset total viewing time per day, and a preset time interval for allowing child to watch media content again.

10. The method of claim 9, wherein the step of recording the child's viewing habit and turning off the video device when the viewing time reaches the viewing allowance time comprising:
recording the child's viewing habit and turning off the video device when the viewing time reaches the child's preset viewing time each time.

11. The method of claim 10, further comprising:
detecting whether a power-on signal is received in a predetermined time after the video device is turned off;
detecting whether the child is watching the media content again when a power-on signal is received in the predetermined time;
detecting whether a time interval away from the last viewing habit is greater than the preset time interval; and
turning off the video device when the time interval away from the last viewing habit is less than the preset time interval.

12. The method of claim 11, further comprising:
calculating the total viewing time on the present day based on the recorded viewing habit;
determining whether the total view time on the present day is greater than the preset total viewing time per day; and
turning off the video device when the total view time on the present day is greater than the preset total viewing time per day.

13. The method of claim 8, wherein the step of detecting whether the child is watching media content on the video device comprises:
storing a characteristic image of the child to be monitored;
capturing a video image of watching position in front of the video device; and
determining that the child is watching the media content on the video device when the captured video image matches with the characteristic image.
